(19) United States
(12) Patent Application Publication
(10) Pub. No.: US 2010/0035759 A1
(43) Pub. Date: Feb. 11, 2010

(54) IN SILICO GENERATION OF ASPARAGINE-LINKED GLYCAN STRUCTURE DATABASES AND USE OF SUCH

(75) Inventor: Jian Min Ren, Belmont, MA (US)

Correspondence Address: Jian Min Ren, 47 Upland Road, Belmont, MA, 02478, US

(73) Assignee: Jian Min Ren

(21) Appl. No.: 12/189,196

(22) Filed: Aug. 10, 2008

(51) Int. Cl. C40B 30/02; C40B 50/02

(52) U.S. Cl. 506/8; 506/24

(57) ABSTRACT

The present invention discloses a method for easy and quick in silico generation of a very large asparagine-linked glycan structure (N-glycan) database and the use of the database and mass spectrometric data for the determination of N-glycan structures. A two dimensional array of single characters is used to represent all distinct outer branch structures of N-glycan structures. We use a computer program and the array to generate a very large number of unique N-glycan structures. For the determination of N-glycan structures based on mass spectrometric data, a search engine is used to search the N-glycan structure database to find N-glycan structure candidates and correlate a predicted mass spectrum of each of the N-glycan structure candidates with an experimental mass spectrum. With the present invention, intact N-glycan structures and their fragments can be displayed graphically.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention discloses a method for determination of glycan structures linked to asparagine residues in glycopeptides and glycoproteins based on mass spectrometric data.

In all living cells, genetic information is transferred from DNA to RNA to proteins. The proteins may go through various post-translational modifications (PTMs) such as phosphorylation and glycosylation. It is estimated that more than 50% of all proteins in mammalian cells are glycoproteins. Glycans on the glycoproteins are involved in various normal and disease related functions. There is growing evidence showing that glycans play crucial roles at various pathophysiological steps of tumor progression. The glycans are also potential biomarkers for cancers and targets for drugs (references: Nature Rev. Drug Disc. 2005, 4, 477-88, Dube, D. H.; Bertozzi, C. R. Glycans in Cancer and Inflammation—Potential for Therapeutics and Diagnostics; Nat. Rev. Cancer. 2005, 5:526-542, Fuster, M. M., and Esko, J. D., The sweet and sour of cancer: glycans as novel therapeutic targets.).

Glycans may be linked to proteins through the amino acid asparagine. These glycans are called asparagine linked glycans (N-glycans). The present invention is mainly applicable to the determination of composition and primary structures of these glycans. Glycans may also be linked to proteins through the amino acids serine and threonine (O-linked glycans, or O-glycans). The current invention does not apply to O-glycans, though approaches similar to the present invention could be used to create O-glycan structure databases.

N-glycans are found mainly on proteins containing the consensus amino acid sequence N-X-S/T where N is asparagine, X is any amino acid except proline, S is serine and T is threonine. Not all asparagine residues in the consensus sequence have glycans attached to them. A given asparagine residue in different molecules of the same protein may have different glycans attached to it. Research has found that structures of N-linked glycans from plant and animal sources fall into three categories termed high mannose, hybrid, and complex. They all have the same basic pentasaccharide core structure (three mannose residues and two N-acetylglucosamine (GlcNAc) residues). The core may contain a bisecting GlcNAc or a fucose attached to the innermost N-acetylglucosamine residue, or both. The high mannose type typically has two to six additional mannose residues linked to the core. The majority of complex type typically has two to four outer branches, but occasionally structures with five outer branches are found. Typically, there are five or fewer monosaccharide residues on each outer branch. The hybrid type has features of both the high mannose type and the complex type glycans (reference: Annu Rev Biochem 1985, 54, 631-64, Kornfeld, R.; Kornfeld, S., Assembly of asparagine-linked oligosaccharides).

Examples of the outer branch monosaccharide sequences include, 1) Gal-GlcNAc, 2) Sialic Acid-Gal-GlcNAc, 3) Gal-GlcNAc with a fucose or a sialic acid attached to the GlcNAc, 4) Sialic Acid-Gal-GlcNAc with a fucose or a sialic acid attached to the GlcNAc, 5) Fucose-Gal-GlcNAc and 6) Fucose-Gal-GlcNAc with a fucose or a sialic acid attached to the GlcNAc. Modifications to the monosaccharide residues on the outer branch may include phosphorylated mannose, sulfated GlcNAc, and mono-, di- and tri-acetylated sialic acid (reference: Annu Rev Biochem 1985, 54, 631-64, Kornfeld, R.; Kornfeld, S., Assembly of asparagine-linked oligosaccharides.)

There are various techniques available to determine N-glycan structures. Yet, most of these techniques tend to be extremely slow and labor intensive. Some of the techniques determine the glycosylation sites but miss the N-glycan structures, yet some other techniques determine the N-glycan structures but miss the glycosylation site information. With mass spectrometry based techniques, most researchers search, interpret and annotate tandem mass spectra of N-glycans manually. It is extremely challenging to characterize glycan structures at high throughput (reference: Proteomics, 2008, 8, 8-20, Nicolle H. Packer, Claus-Wilhelm von der Lieth, Kiyoko F. Aoki-Kinoshita, Carlito B. Lebrilla, James C. Paulson, Rahul Raman, Pauline Rudd, Ram Sasisekharan, Naoyuki Taniguchi, William S. York, “Frontiers in glycomics: bioinformatics and biomarkers in disease. An NIH white paper prepared from discussions by the focus groups at a workshop on the NIH campus, Bethesda Md. (September 11-13, 2006)”).

At least, part of the challenge originates from the fact that, unlike proteins whose linear sequences can be predicted from gene sequences and databases can be assembled, N-glycans are produced by joined functions of many different enzymes and there are no templates to predict the monosaccharide sequences in the outer branches (reference: Varki et al., Essentials of Glycobiology. Cold Springs Harbor Laboratory Press, La Jolla, Calif., 1999.).

There are glycan structure databases curated from published data, such as Complex Carbohydrate Structure Database (CCSD, or CarbBank, http://biol.lancs.ac.uk/gig/pages/gag/carbbank.htm), the KEGG GLYCAN database (http://www.genome.ip/kegg/glycan/), and GlycoSuiteDB (reference: Nucleic Acids Res 2003, 31, (1), 511-3, Cooper, C. A.; Joshi, H. J.; Harrison, M. J.; Wilkins, M. R.; Packer, N. H., GlycoSuiteDB: a curated relational database of glycoprotein glycan structures and their biological sources. 2003 update.). The KEGG GLYCAN database (http://www.genome.jp/kegg/glycan/) contains 10 938 entries. The database is a collection of experimentally determined glycan structures, including all unique structures taken from CarbBank. There is a glycan structure database from Germany (http://www.lycosciences.de/sweetdb/index.php) which allows search and access of three data sources: CarbBank structures and literature references, NMR data taken from SugarBase and 3D co-ordinates generated with SWEET-II. Also, there is a bacterial carbohydrate structure database from Russia with some 9,000 entries (http://www.glvco.ac.ru/bcsdb/start.shtml).

All these databases contain limited number of unique glycan structures (fewer than 49,000 in CCSD), and the inventor of the present invention does not know any available way to search the CCSD database efficiently for automatic determination of N-glycan structures based on mass spectrometric data. Manual curation of N-glycan structures from published data could be labor intensive, slow and costly. Much more so is the initial determination of N-glycan structures.

SimGlycan (http://www.premierbiosoft.com/glycan/index.html) has a built-in database of theoretical fragments of over 8,000 glycans. How the database was created is unknown to the inventor of the present invention.

Several linear sequences were used to describe one specific N-glycan structure and collections of these linear sequences for different N-glycan structures could be considered as an N-glycan structure database (reference: J. Proteome Res., 2007, 6 (8), 3162-3173. Jian Min Ren, Tomas Rejtar, Lingyun Li, and Barry L. Karger, “N-Glycan Structure Annotation of Glycopeptides Using a Linearized Glycan Structure Database (GlyDB)”). Theoretical fragments generated from each of the linear sequences were compared to experimental peak lists using a commercial database search engine, SEQUEST (originally developed for peptide amino acid sequence determinations). Since each of the linear sequences could only match part of the experimental tandem mass spectrum of any branched N-glycan structure, the degree of the match was low. Also, the representation of monosaccharide sequences in the outer branches was not separated from the representation of the core structure (as in the present invention). Some structural information on the monosaccharide sequences in the outer branches of the fragments was lost. The supporting information for the publication briefly discussed the generation of the database (see: http://pubs.acs.org/subscribe/journals/jprobs/suppinfo/pr070111y/pr070111ysi20070514_{—}064328.pdf. The representation of N-glycan structures as disclosed in the current invention is different in that the outer branch structures and the core structure of each N-glycan structure is represented separately, and a single two dimensional array is used to represent the outer branch structures.

There is an urgent need for an N-glycan structure database and software for efficient retrieval of information in the database for further progress of glycomics and glycobiology (reference: Proteomics, 2008, 8, 8-20, Nicolle H. Packer, Claus-Wilhelm von der Lieth, Kiyoko F. Aoki-Kinoshita, Carlito B. Lebrilla, James C. Paulson, Rahul Raman, Pauline Rudd, Ram Sasisekharan, Naoyuki Taniguchi, William S. York, “Frontiers in glycomics: bioinformatics and biomarkers in disease. An NIH white paper prepared from discussions by the focus groups at a workshop on the NIH campus, Bethesda Md. (Sep. 11-13, 2006)”).

The present invention discloses a method for easy and quick in silico generation of very large N-glycan structure databases and the use of the database and mass spectrometric data for the determination of N-glycan structures at high throughput.

### BRIEF SUMMARY OF THE INVENTION

The object of the present invention is to generate a very large N-glycan structure database for composition and primary structure determination of N-glycan structures at high throughput using mass spectrometric data. According to the present invention, each column in an initial, larger two dimensional array is used to represent the monosaccharide sequence of each unique outer branch structure of N-glycan structures. A computer program is used to generate various unique combinations of said columns in said initial larger two dimensional array. Each unique combination, together with a unique N-glycan core structure also specified by the computer program, represents a unique N-glycan structure. A collection of these unique N-glycan structures forms an N-glycan structure database. The outer branch structures of each entry in the database are represented by a smaller two dimensional array. The core structure of each entry in the database is specified by specifying if a bisecting GlcNAc is present in the core and if a fucose is attached to the innermost GlcNAc. The N-glycan structure database is then used by a search engine for the determination of composition and primary structures of N-glycan structures from mass spectra and tandem mass spectra of glycopeptides, un-derived and derived N-glycans. The advantages of the present invention include easiness, speed and flexibility of the N-glycan structure database generation at minimum cost, the possibly very large number of entries in the database, and easiness of information retrieval from the database for determination of N-glycan structures at high throughput.

### BRIEF DESCRIPTION OF THE DRAWINGS

FIG. 1. Graphical representation of an N-glycan structure. ▴ fucose ♦ sialic acid ◯ galactose ▪ GlcNAc mannose.

FIG. 2. Graphical representation of the outer branches of the N-glycan structure in FIG. 1. ▴ fucose ♦ sialic acid ◯ galactose ▪ GlcNAc mannose.

FIG. 3. Graphical representation of the core structure of the N-glycan structure in FIG. 1. ▴ fucose ▪ GlcNAc mannose.

FIG. 4. Using strings of characters to represent the monosaccharide residues on the two outer branch structures as represented in FIG. 2.

FIG. 5. Using single characters to represent the monosaccharide residues on the two outer branch structures as represented in FIG. 2 and FIG. 4. F: fucose; S: sialic acid; G: Gal; T: GlcNAc.

FIG. 6. An array representation of the same two outer branch structures as represented in FIG. 2, FIG. 4 and FIG. 5. F: fucose; S: sialic acid; G: Gal; T: GlcNAc.

FIG. 7. A section of pseudo computer code for the generation of an N-glycan structure database.

FIG. 8. One combination of outer branch structures that can be generated by a computer program implementing the pseudo computer code in FIG. 7.

FIG. 9. Another combination of outer branch structures that can be generated by a computer program implementing the pseudo computer code in FIG. 7.

FIG. 10. Another combination of outer branch structures that can be generated by a computer program implementing the pseudo computer code in FIG. 7.

FIG. 11. Another outer combination of outer branch structures that can be generated by a computer program implementing the pseudo computer code in FIG. 7.

FIG. 12. The outer branch structures after loss of a fucose from the original outer branch structures shown in FIG. 8.

FIG. 13. Output of the computer program showing an N-glycan structure found on a peptide, “NEEYNK”, from human alpha-1-acid glycoprotein. The average molecular mass of the peptide plus that of one proton is 796.8 Da.

### DETAILED DESCRIPTION OF THE INVENTION

Protein glycosylation is important for proper functioning of proteins, yet N-glycan structure characterization is extremely challenging due to their structural complexity (reference: Proteomics, 2008, 8, 8-20, Nicolle H. Packer, Claus-Wilhelm von der Lieth, Kiyoko F. Aoki-Kinoshita, Carlito B. Lebrilla, James C. Paulson, Rahul Raman, Pauline Rudd, Ram Sasisekharan, Naoyuki Taniguchi, William S. York, “Frontiers in glycomics: bioinformatics and biomarkers in disease. An NIH white paper prepared from discussions by the focus groups at a workshop on the NIH campus, Bethesda Md. (Sep. 11-13, 2006)”). At least, part of the challenge originates from lack of N-glycan structure databases. N-glycans are synthesized by the functioning of many different enzymes and there are no templates to predict their structures (reference: Varki et al., Essentials of Glycobiology. Cold Springs Harbor Laboratory Press, La Jolla, Calif., 1999.) This is contrary to the situation of mass spectrometry based proteomics whose success is largely due to the availability of protein databases and database search engines.

The present invention discloses a method for in silico generation of an N-glycan structure database and use of the database, mass spectrometric data and a database search engine for the determination of N-glycan structures.

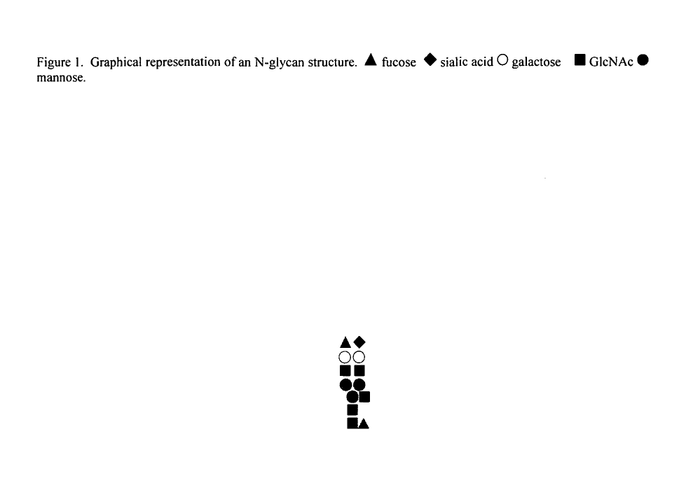

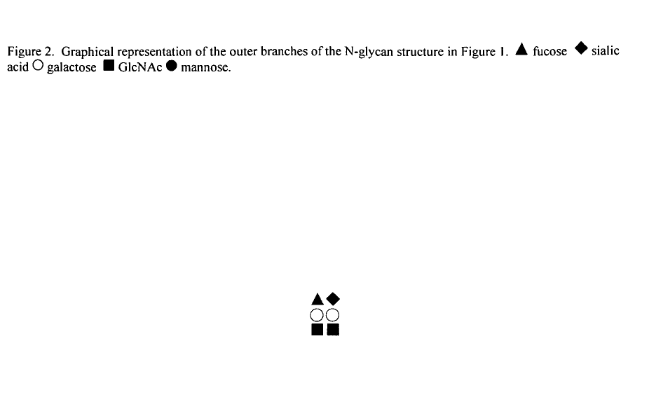

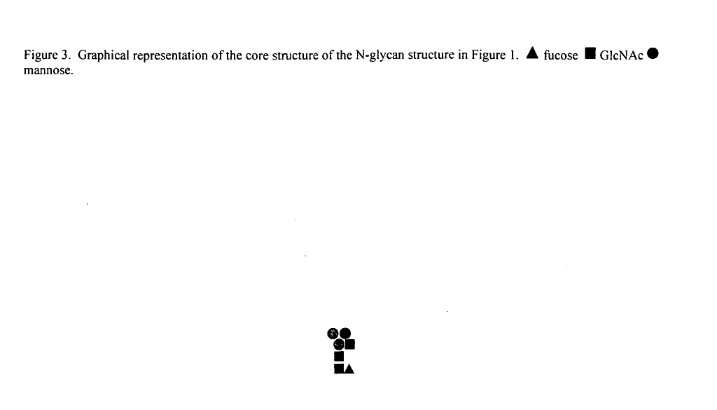

Assume that a complex type N-glycan has two outer branches. The monosaccharide sequence on one outer branch (Branch 1) is frucose-galactose-GlcNAc, and the monosaccharide sequence on the other outer branch (Branch 2) is sialic acid-galactose-GlcNAc. Also assume that its core structure has a bisecting GlcNAc and a fucose attached to the innermost GlcNAc. We could represent the intact N-glycan structure by FIG. 1 where ▴ represents fucose; ♦, sialic acid; ◯, galactose; ▪, GlcNAc; and , mannose. For the purpose of description of the present invention, we use sialic acid to mean N-acetylneuraminic acid.

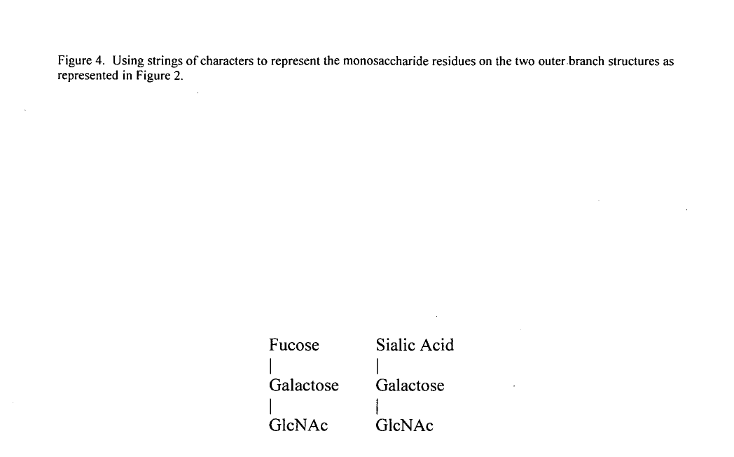

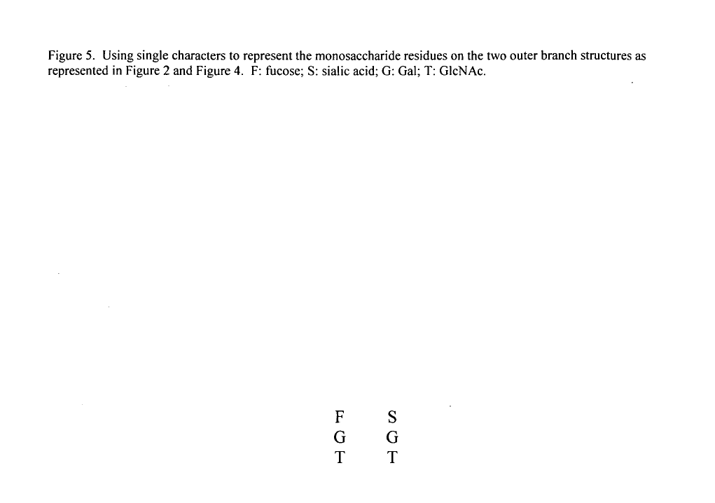

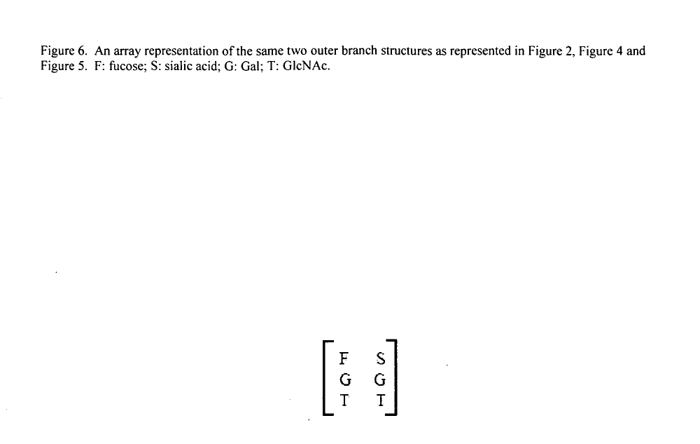

For easier manipulation by digital means, we could represent the outer branch structures and the core structure separately. Thus, the outer branch structures are represented by FIG. 2, and the core structure, by FIG. 3. The combination of FIG. 2 and FIG. 3 represents the initial intact N-glycan structure as represented in FIG. 1.

The outer branch structures. First, we look at the outer branch structures as represented in FIG. 2. For those of us who are familiar with mathematics and computer science, FIG. 2 can be considered as similar to an array of symbols with two columns and three rows, with each column corresponding to one outer branch of the N-glycan structure, and the row positions of the monosaccharide residues in each column corresponding to their relative positions in the outer branch. FIG. 2 is a graphical representation. In the present invention, we could choose to use two dimensional arrays whose elements are graphical symbols to represent N-glycan structures. But, graphical symbols are harder to manipulate digitally. For easier manipulation by digital means, we may choose to use two dimensional arrays of strings of characters or even arrays of single characters to represent the N-glycan structures and convert them back to graphical symbols later for graphical displays when necessary. If we choose to use strings of characters to replace the graphical symbols in FIG. 2, we may use the representation as shown in FIG. 4.

To further simplify the representation in FIG. 4, we could choose to use single characters to represent the monosaccharide residues. For example, if we use F to represent fucose, S to represent sialic acid, G to represent galactose and T to represent GlcNAc, we could use a simpler array to represent the same outer branch structures as represented in FIG. 2 and FIG. 4, as shown in FIG. 5.

FIG. 6 represents the same two outer branch structures as in FIG. 5, but in the same format as typically used in mathematics for the representation of a two dimensional array.

The advantages of using two dimensional array for the representation of the outer branch structures of N-glycan structures are numerous. Firstly, it allows easy in silico generation of an N-glycan structure database by using a computer program. To start, we could have an initial, larger two dimensional array similar to the one in FIG. 6, but, with each column corresponding to one unique monosaccharide sequence of the outer branch structures of N-glycans. Then, we can specify the maximum number of outer branches that any N-glycan structure generated in the database can have. We use for-loops in the computer program to generate various unique combinations of the columns representing the unique monosaccharide sequences in the initial larger two dimensional array. Each of the combinations is represented by a smaller two dimensional array, similar to the one shown in FIG. 6. And, each of the combinations (or the smaller two dimensional array) can be thought as a representation of the outer branch structures of an N-glycan structure. This smaller two dimensional array, together with a unique core structure also specified by the computer program, specifies a unique N-glycan structure and becomes an entry in the N-glycan structure database. Secondly, the array representation of the outer branch structures allows graphical display of intact N-glycan structures. Thirdly, the array representation of the outer branch structures allows graphical display of fragment ions of N-glycan structures. This last point is especially important for visual inspection of matches between predicted tandem mass spectra of N-glycan structures and experimental tandem mass spectra.

Similarly, one can easily choose to use rows (instead of columns) in the initial larger two dimensional array to represent the unique outer branch structures of N-glycan structures, and accordingly, to use rows in the smaller two dimensional array to represent the outer branch structures of an N-glycan structure entry in the database.

The pentasaccharide core structures. Now, we will discuss the representation of the pentasaccharide core structure of N-glycan structures. From biosynthetic rules of N-glycans, we know that all N-glycan structures of plant and animal origins have a basic pentasaccharide core (reference: Annu Rev Biochem 1985, 54, 631-64, Kornfeld, R.; Kornfeld, S., Assembly of asparagine-linked oligosaccharides.). We know that the pentasaccharide core has three mannoses and two GlcNAc which are arranged in a specific structure. Alternatively, the core may have a bisecting GlcNAc, or a fucose attached to the innermost GlcNAc, or both. So, the total number of possible unique core structures is four. To represent the basic pentasaccharide core structures, we could choose to use a string of characters, for example, MMMTT, where M represents mannose and T represents GlcNAc, or we could choose to use another two dimensional array to represent it. However, because the basic pentasaccharide core is always there, we do not have to represent it explicitly. We will use this information when we need it, without representing the core structure explicitly for each N-glycan structure in the database. For example, when we calculate the molecular mass of an intact N-glycan structure or a fragment of an N-glycan structure, we will take into consideration of the molecular mass of the monosaccharide residues in the core as appropriate. However, we do need to specify if a bisecting GlcNAc is present or if a fucose is attached to the innermost GlcNAc, or if both a bisecting GlcNAc is present and a fucose is attached to the innermost GlcNAc.

In the present invention, we will consider the following four types of N-glycan core structures, the basic pentasaccharide core only, the core with a bisecting GlcNAc, the core with a fucose attached to the innermost GlcNAc, and the core with a bisecting GlcNAc and a fucose attached to the innermost GlcNAc. We use a Boolean variable to specify if a bisecting GlcNAc is present, and another Boolean variable to specify if a fucose is attached to the innermost GlcNAc.

Optionally, one may choose to use four two-dimensional arrays to represent the four N-glycan core structures. Each element in said two dimensional array could be a symbol, a string of characters or a single character.

Using a computer program to generate an N-glyean structure database. To generate the N-glycan structure database, we first use an initial, larger two dimensional array to store all the unique monosaccharide sequences on the outer branches of N-glycan structures. Optionally, the user of the computer program may enter part or all of the unique monosaccharide sequences of the outer branches of N-glycan structures into the computer program. These unique monosaccharide sequences can be those that are known to exist. Or, some of these monosaccharide sequences may be those sequences whose existence one wants to test or verify.

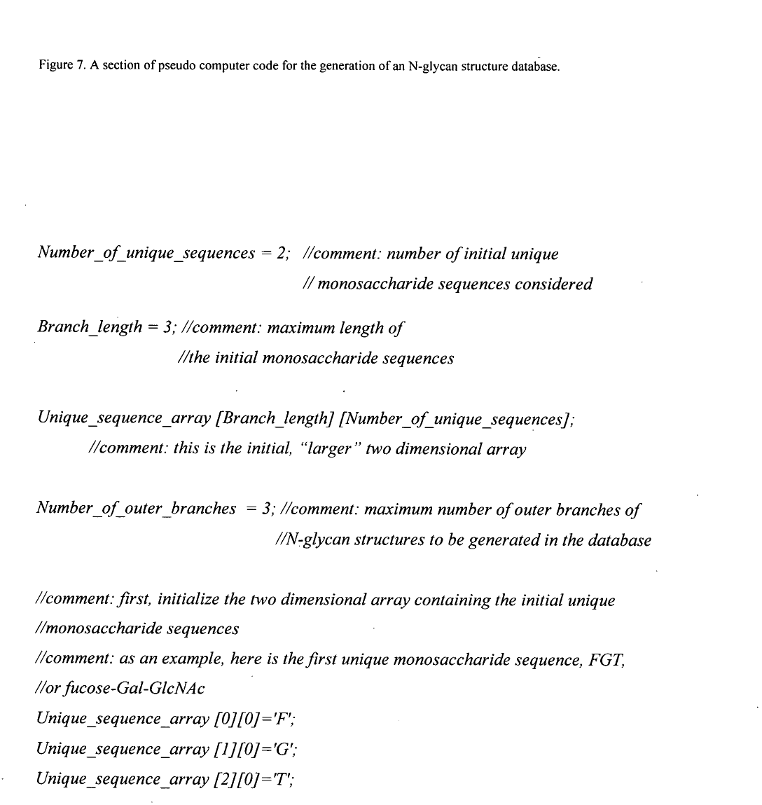

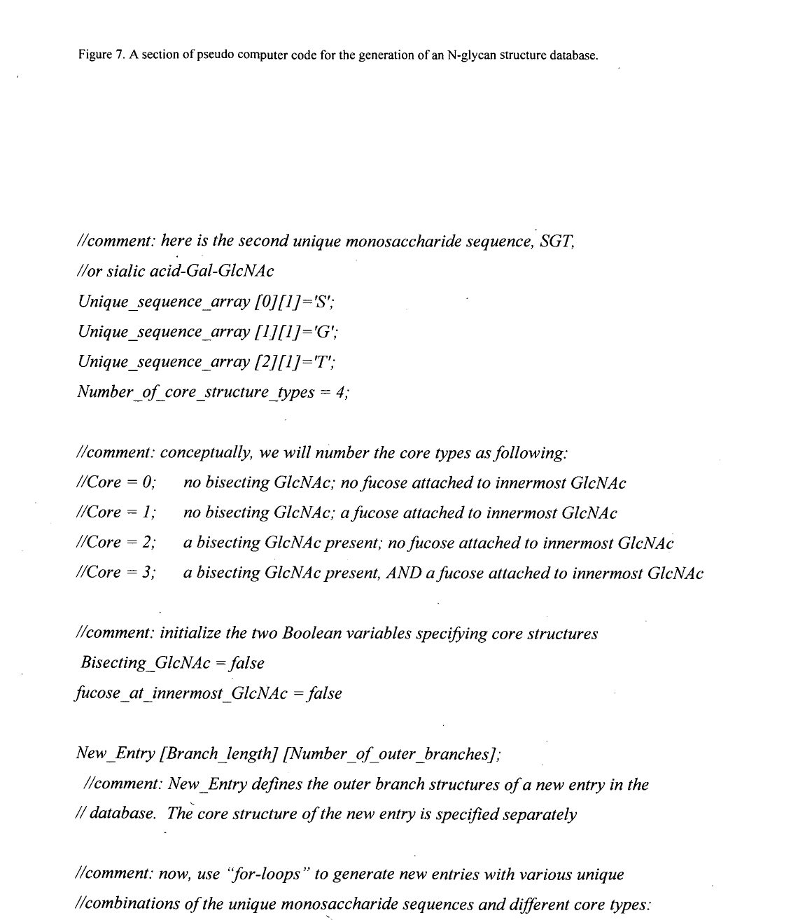

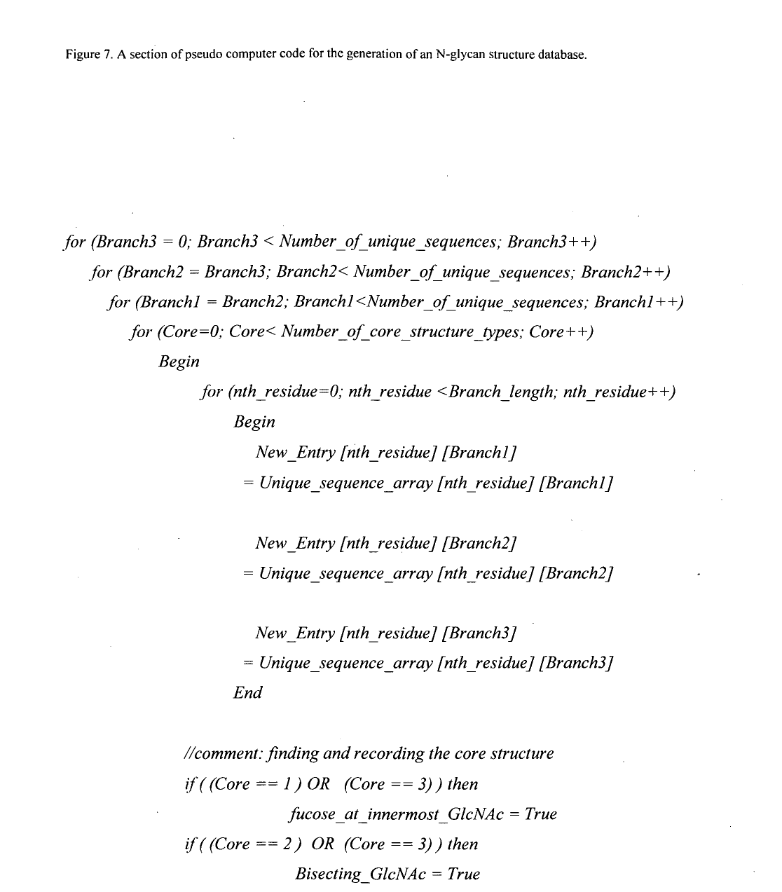

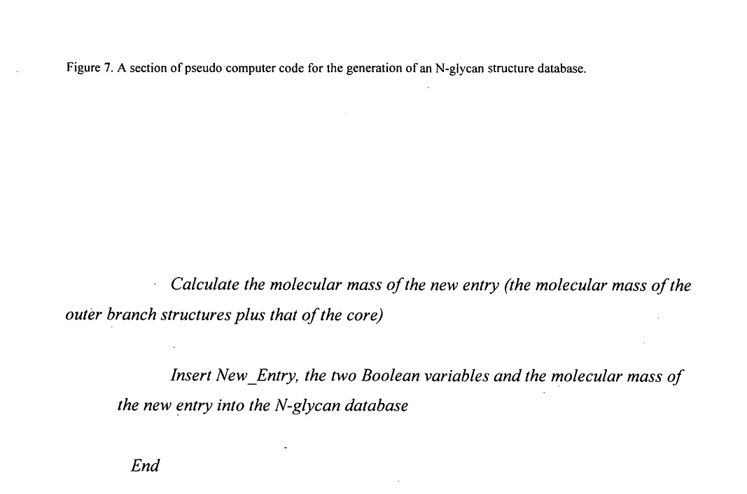

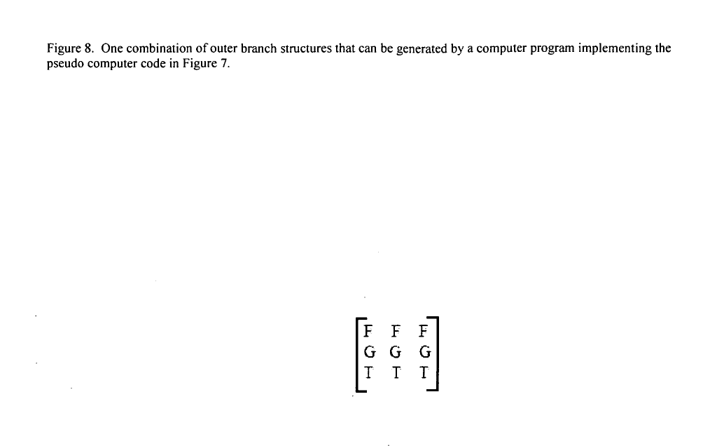

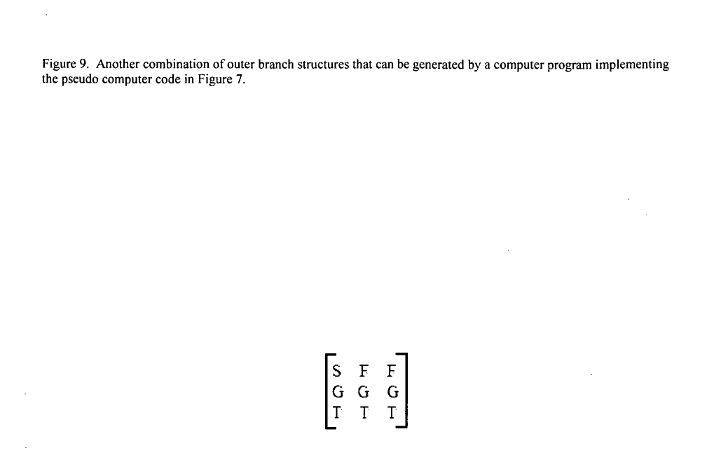

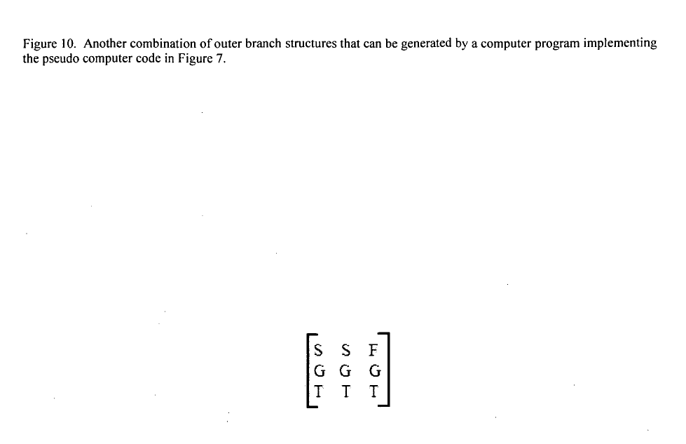

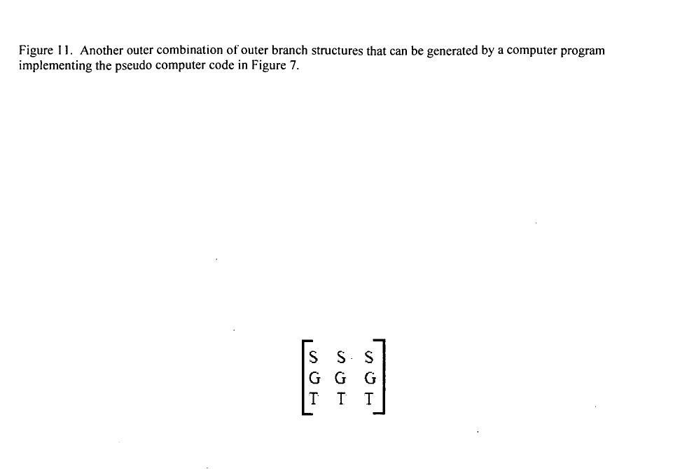

As a simple example, we will use the pseudo computer code in FIG. 7 to generate a very small N-glycan structure database from only two unique monosaccharide sequences representing the outer branch structures of some N-glycan structures. Three is the maximum length of the two unique monosaccharide sequences chosen in this example. We will use an initial two dimensional array with two columns and three rows to represent the two unique monosaccharide sequences under consideration. We will include the four types of N-glycan core structures as discussed above. Further, for simplicity, we will limit the maximum number of the outer branches on any N-glycan structure in the database generated by the computer program to three.

FIG. 7 shows a section of the pseudo computer code.

A computer program implementing the pseudo computer program code in FIG. 7 can generate N-glycan structures with four unique combinations of the outer branch structures. The four unique combinations may be represented by the four two dimensional arrays as shown in FIG. 8 to FIG. 11. These four different combinations of the outer branch structures are then combined with the four different types of core structures to generate a total of 4×4=16 unique N-glycan structures in the database.

In the present invention, we consider any two N-glycan structures are the same if they have the same core structure and if all the outer branch structures in either of the two can be found on the outer branch structures of the other. In other words, we do not attempt to signify the ordering of the outer branches of the N-glycan structures.

In the above pseudo computer code, if we expand to include a unique monosaccharide sequence whose monosaccharide residues are all NULL, we could generate N-glycan structures with zero, one, two and three outer branches.

In FIG. 7, for simplicity, we only include two unique monosaccharide sequences in the initial two dimensional array. However, in reality, the same pseudo computer code can be used to generate much larger N-glycan structure databases. As can be easily postulated that, if, in the initial two dimensional array, we include all the unique monosaccharide sequences known to exist on the outer branch structures of N-glycan structures (including one whose monosaccharide residues are all NULL), we could easily generate a database with a very large number of unique N-glycan structures. We can even include new N-glycan structures with hypothetical outer branch structures.

The pseudo computer program code shown in FIG. 7 contains the unique monosaccharide sequences which are used to generate the outer branch structures of entries in the database. Alternatively, the computer program can be created so that users of the computer program themselves can input monosaccharide sequences of outer branch structures of N-glycans into the computer program to generate N-glycan structure databases whose entries containing outer branch structures with the monosaccharide sequences of their choices. This feature can be useful when the monosaccharide sequences are proprietary, or the monosaccharide sequences are unknown when the computer program is created.

In nature, although the number of N-glycan structures existing can be very large, the number of unique monosaccharide sequences on the outer branches of all the known N-glycan structures is much smaller. If we assume that the number of unique monosaccharide sequences on the outer branches is 30, the maximum number of outer branches of N-glycan structures to be generated in the database is four, and the number of core structures to be considered is four, it can be shown that more than 160,000 distinct N-glycan structures can be generated. The unique monosaccharide sequences on the outer branches can be those found by research or some hypothetical monosaccharide sequences whose existence one wishes to verify. If, among the 30 unique monosaccharide sequences, we include one whose monosaccharide residues are all NULL, the resulted 160,000 N-glycan structures would contain those with zero, one, two, three or four outer branches. If we include an outer branch structure with mannoses only, we could easily generate high mannose type N-glycans and hybrid type N-glycans too. All the N-glycans may have any of the four types of core structures as discussed above. Similarly, from 40 unique monosaccharide sequences, we could easily generate a database with some 500,000 unique N-glycan structures. As a rough comparison, the most extensive glycan structure database, Complex Carbohydrate Structure Database (CCSD), contains approximately 49,000 records. CCSD took many scientists multiple years and substantial financial resources to build (though it contains more detailed information). A commercially available glycan structure database, GlycoSuiteDB, contains fewer than 10,000 entries (https://glycosuite.proteomesystems.com/).

Since we include the molecular mass of each of the N-glycan structures in the database, we can search the database for all N-glycans whose molecular masses are within a predetermined tolerance of a given molecular mass. We need this capability when we try to match experimental tandem mass spectra with predicted mass spectra of fragment ions of N-glycan structures in the database.

Rotating the initial two dimensional arrays by 90, 180 or 270 degrees (or any other degrees) would produce similar N-glycan structure databases.

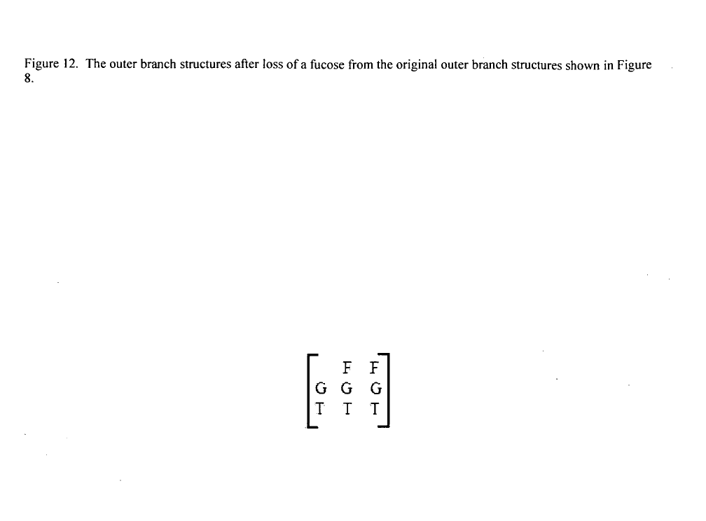

Generation of predicted mass spectra of fragment ions of N-glycan structures from the database. For the generation of a fragment ion due to a glycosidic bond cleavage of an N-glycan structure with the outer branch structures shown in FIG. 8, we simply change one or more elements in the two dimensional array to a NULL or a space. FIG. 12 shows the outer branch structures of a fragment ion due to loss of a fucose on one of the outer branches. The molecular mass of the resulted fragment ion can be easily calculated.

Similarly, we can generate other fragment ions due to cleavages of glycosidic bond of the outer branch structures by changing one or more elements in the two dimensional array to a NULL or a space. Note that we know the outer branch structures of each fragment ions generated this way. Later on, we can display these outer branch structures graphically when we plot the predicted mass spectrum of the N-glycan structure matched to an experimental tandem mass spectrum. This is important for visual inspection of any match between the predicted mass spectrum and any experimental tandem mass spectrum.

We can also generate fragment ions due to core fragmentation, or loss of a bisecting GlcNAc, or loss of any fucose attached to the innermost GlcNAc.

All these fragment ions may or may not have peptides or other chemical moieties attached. The chemical moieties, if any, may be attached to the N-glycans by chemical reaction means (i.e., chemical derivatization). Or, these fragment ions may also be generated from native N-glycans. By calculating the total molecular masses of the fragment ions (with peptides or other chemical moieties attached, as appropriate) and assigning the fragment ions different charges, we then get the predicted tandem mass spectrum of the original N-glycan structure under consideration.

It is observed that, in experimental tandem mass spectra of glycopeptides obtained under low energy collision induced dissociation (CID), mainly the glycosidic bonds are cleaved. The peptide backbones are not cleaved to large degrees. So we only need to include fragment ions due to glycosidic bond breakage.

However, sometimes, experimental tandem mass spectra are obtained under higher collision energy. By including fragments due to cross ring fragmentation in the predicted tandem mass spectrum, it is possible to gain linkage information from the experimental tandem mass spectra obtained with higher collision energy. It may also be possible to gain linkage information from the intensities of the experimental low energy CID tandem mass spectra.

Matching predicted tandem mass spectra of N-glycan structures to experimental tandem mass spectra. In mass spectrometry based proteomics, there are various database search engines available for searching protein sequence databases so as to match predicted tandem mass spectra of peptides to experimental tandem mass spectra of peptides, for the identification of peptides. Among these search engines are OMSSA, X!Tandem, Mascot and SEQUEST (for SEQUEST, see U.S. Pat. No. 5,538,897).

In the present invention, we disclose a method for the generation of an N-glycan structure database, and for the generation of predicted mass spectra of N-glycan structures in the database. We can then use a database search engine with a spectra matching algorithm very similar to any of the above mentioned search engines to match the predicted mass spectra to any experimental tandem mass spectra.

To find N-glycan structures on a glycoprotein, one could use the approach discussed below. First, preferably, one separates the glycoprotein of interest from contaminants. Then the glycoprotein is digested with a protease. We will use the protease, trypsin, as an example. The digest is then loaded onto a liquid chromatography column (such as a C18 column), and experimental mass spectra and collision induced dissociation (CID) tandem mass spectra of glycopeptides and peptides are obtained. Since glycosidic bonds are weaker than the bonds between amino acids, glycosidic bonds in the glycopeptides are fragmented preferably during CID.

To find different N-glycan structures on one specific asparagine residue of the glycoprotein, we first find the molecular mass of the bare, tryptic peptide backbone containing the asparagine residue. Then, for a given experimental tandem mass spectrum, the database search engine calculates the theoretical molecular mass of the N-glycan structure part based on the parent ion's charge, the parent ion's mass-to-charge ratio, and the molecular mass of the bare peptide backbone. Then the database search engine searches the N-glycan structure database created in the present invention to obtain a list of N-glycan structure candidates whose molecular masses are within a predetermined mass tolerance of said theoretical molecular mass of the N-glycan structure part of the glycopeptide. For each N-glycan structure in the list of N-glycan structure candidates, the search engine generates a predicted mass spectrum of fragment ions of said N-glycan structure with and without said given peptide attached, as discussed above. Then, the search engine calculates at least a first measure for the predicted mass spectrum, said first measure being an indication of the closeness-of-fit between said predicted mass spectrum and said given experimental tandem mass spectrum.

If there are more than one asparagine residues in the glycoprotein of interest, we repeat the above process.

In the present invention, we choose to combine the computer program for N-glycan structure database generation and the database search engine into one computer program. Thus, the N-glycan structure database generated only need to exist in computer memory. However, we may choose to output the database and save it to a computer file so that the database can be used for other purposes.

The above approach may still work if one cannot separate the glycoprotein of interest from all contaminants, or one chooses not to use a liquid chromatography column for peptide and glycopeptide separation.

### Example #1

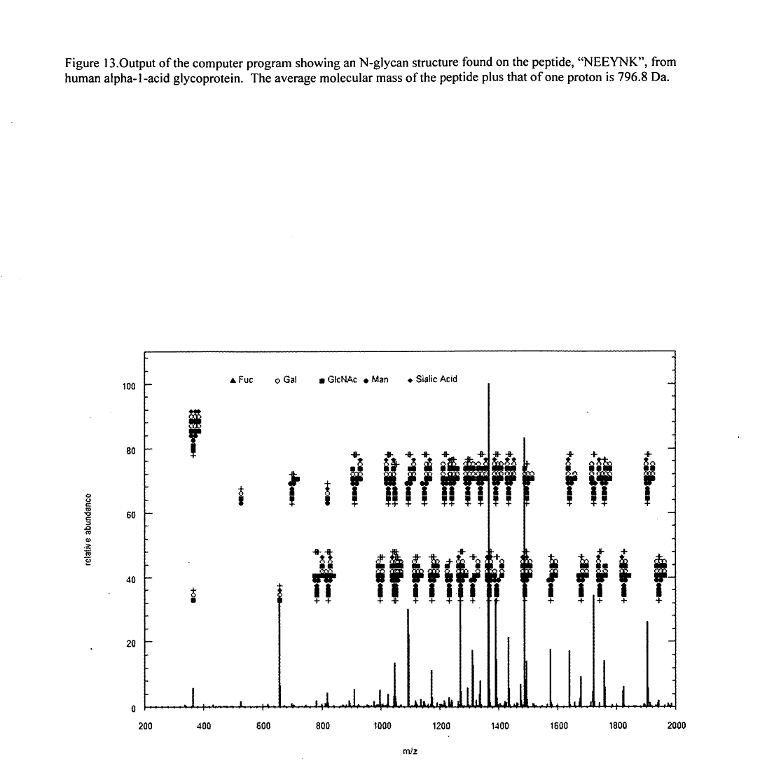

FIG. 13 shows the output of the computer program for one of the N-glycan structures found on the peptide, “NEEYNK”, from human alpha-1-acid glycoprotein. The raw mass spectrometric data was downloaded from the open proteomics database at http://bioinformatics.icmb.utexas.edu/OPD. The sample contained 75 pmol of human alpha-1-acid glycoprotein digested with trypsin. Peptides and glycopeptides were separated by a C18 column using a reverse phase elution of 140 min and a final acetonitrile concentration of 65%. The mass spectrometer used was an LCQ (ThermoFisher Scientific, San Jose, Calif., USA) with positive electrospray ionization and collision induced dissociation.

The amino acid sequence of the peptide, “NEEYNK”, is the sequence from Residue 52 to Residue 57 in the amino acid sequence listing as shown in the paper copy of the Sequence Listing and in the Sequence Listing in the file “SequenceListing1_JianMinRen” in the compact disc included in this application. The average molecular mass of the peptide plus that of one proton is 796.8 Da. By inputting this molecular mass, 796.8, into the computer program (containing the code for database generation and the database search engine) and searching all the experimental tandem mass spectra against the N-glycan structure database generated, we found the N-glycan structure shown in FIG. 13 (the intact structure in the upper left corner of the graph), and a few other N-glycan structures. Also shown in FIG. 13 are the glycan fragment structures aligned with the experimental peaks that they match.

In reality, the true output of the computer program in the present invention is in color. Only for the purpose of this current patent application, the output shown in FIG. 13 is in black and white.

On a typical personal computer, it took about two hours to generate the N-glycan structure database with 160,000 entries and to search some 5,000 tandem mass spectra against the database generated. As a comparison, it may take an experienced researcher hours to manually search, interpret and annotate one tandem mass spectrum of glycopeptides. So the current approach is potentially thousands times faster.

Since the present invention teaches how to search N-glycan structures on one peptide at a time, we know the glycosylation site of any N-glycan structures found, to a large degree. However, if any one peptide has more than one unknown post-translational modifications (PTMs), the present invention cannot be used. One way to solve the problem is to use another protease to digest the original glycoprotein so as to get a peptide with only one glycosylation site. Also, if two bare peptide backbones have essentially the same molecular mass, we would not know the specific sites that the N-glycan structures found attach to.

In FIG. 13, the intact N-glycan structure found on the peptide is shown in the upper left corner of the plot. If a spectra peak on the experimental tandem mass spectrum is matched to a predicted fragment ion of the glycopeptide, the structure of the fragment ion is displayed in vertical alignment with the spectra peak position on the plot of the experimental tandem mass spectrum. Most, but not all the intense peaks on the spectrum are assigned to structures of fragment ions, an indication of good matches between the experimental and the predicted mass spectra. A plus sign, “+”, below the structure of a fragment ion indicates that the peptide is attached to the fragment ion. One plus sign, “+”, above the structure of a fragment ion indicates that the fragment ion is a +1 ion, and two plus signs, “++”, mean that the fragment ion is a +2 ion, etc.

Though we used collision induced dissociation of N-glycan structures as an example, our approach should be equally applicable to experimental tandem mass spectra obtained with other dissociation means (such as multiple photo dissociation, and dissociations due to post source decay) where tandem mass spectra peaks are mainly due to glycosidic bond cleavages.

Limitations of the present invention: the N-glycan structure database generated by the present invention does not contain any linkage information. However, it may be possible to add fragment ions due to cross-ring fragmentation to the predicted mass spectra, so as to determine the linkage between monosaccharide residues based on experimental tandem mass spectra obtained with higher collision energy.

What is claimed is:

1. A method for representing asparagine linked glycan (N-glycan) structures and in silico generation of an N-glycan structure database, comprising
representing the core structure and the outer branch structures of each N-glycan structure separately;
representing the monosaccharide sequence of each unique outer branch structure of N-glycan structures using one column of an initial, larger two dimensional array;
the row number of each element in said array column corresponding to the relative position of the monosaccharide residue in said outer branch structure;
generating a database of N-glycan structures using said initial, larger two dimensional array;
the outer branch structures of each entry in said database being represented by a smaller two dimensional array;
the array columns of said smaller two dimensional array being a unique combination of array columns in said initial, larger two dimensional array; and
the core structure of each entry in said database being defined by specifying if a bisecting N-acetylglucosamine (GlcNAc) is present in the core structure and if a fucose is attached to the innermost GlcNAc in the core structure.

2. A method, as claimed in claim 1, where a computer program is used to generate said various unique combinations of the array columns of said initial, larger two dimensional array.

3. A method, as claimed in claim 2, where conditional loops or repetitive control structures (such as “for loops”, “while loops”, “for-each loops” and “do-while loops”, or combinations of such) are used in said computer program to generate said various unique combinations of the array columns of said initial, larger two dimensional array.

4. A method, as claimed in claim 1, where each element in said array columns can be any character or combinations of characters from the Unicode character set including the space character and the NULL character.

5. A method, as claimed in claim 1, where Boolean variables are used to specify whether a bisecting GlcNAc is present in the N-glycan core structure and whether a fucose is attached to the innermost GlcNAc in the core structure.

6. A method, as claimed in claim 1, where the molecular mass of each entry in the N-glycan structure database is calculated and recorded in said database.

7. A method, as claimed in claim 1, where the N-glycan core structure in said database is represented by a two dimensional array.

8. A method, as claimed in claim 1, where said monosaccharide sequences of the outer branch structures can be any monosaccharide sequences known to exist naturally or produced by chemical reaction means, including sequences containing permethylated monosaccharides and any other modified monosaccharides such as phosphorylated mannose, sulfated GlcNAc, various acetylated sialic acids, and monosaccharides with another monosaccharide attached on the side (such as a GlcNAc with a fucose or a sialic acid attached on the side).

9. A method, as claimed in claim 1, where some of the monosaccharide sequences are hypothetical.

10. A method, as claimed in claim 1, where the database of N-glycan structures is generated manually.

11. A method, as claimed in claim 1, where the asparagine linked glycan (N-glycan) structures can originate from any living organism, including microorganisms, vertebrates, invertebrates and plants.

12. A method, as claimed in claim 1, where rows in stead of columns of said initial, larger two dimensional array are used to represent the unique outer branch structures of N-glycan structures.

13. A method for the use of the N-glycan structure database generated in claim 1 for the determination of N-glycan structures attached to peptides, comprising
for a given peptide to which N-glycans are possibly attached and a given experimental tandem mass spectrum, calculating the theoretical molecular mass of the N-glycan structure part based on the parent ion's mass-to-charge ratio, the parent ion's charge, and the molecular mass of the peptide backbone;
searching the N-glycan structure database created in claim 1 to obtain a list of intact N-glycan structures with molecular masses within a predetermined mass tolerance of said theoretical molecular mass of the N-glycan structure part;
for each intact N-glycan structure in said list of intact N-glycan structures, generating a predicted mass spectrum of fragment ions of said intact N-glycan structure with and without said given peptide attached; and
calculating at least a first measure for said predicted mass spectrum, said first measure being an indication of the closeness-of-fit between said predicted mass spectrum and said given experimental tandem mass spectrum.

14. A method, as claimed in claim 13, where said predicted mass spectrum of fragment ions of said intact N-glycan structure is generated by changing one or more elements in the two dimensional array representing the outer branch structures of said intact N-glycan structure to NULL to indicate loss of one or more monosaccharide residues from the outer branches of the intact N-glycan structure due to glycosidic bond cleavages during the mass spectrometric analysis process;
calculating and recording the mass-to-charge ratios of the fragment ions with different charges, with and without the N-glycan structure core attached, and with and without the given peptide attached;
generating fragment ions due to core fragmentation by removing one or more monosaccharide residues from the core, including removing any existing bisecting GlcNAc and fucose attached to the inner most GlcNAc to indicate loss of one or more monosaccharide residues from the core structure due to glycosidic bond cleavages during the mass spectrometric analysis process; and
calculating and recording the mass-to-charge ratios of the fragment ions due to core fragmentation with different charges, with and without the peptide attached.

15. A method, as claimed in claim 14, where the two dimensional arrays representing the N-glycan fragments due to outer branch fragmentation are used for graphical display of the fragment ions if they are matched to spectral peaks of the given experimental tandem mass spectrum.

16. A method, as claimed in claim 13, where the experimental tandem mass spectrum is obtained using one of a triple quadrupole mass spectrometer, a Fourier-transform cyclotron resonance mass spectrometer, a tandem time-of-flight mass spectrometer, a quadrupole ion trap mass spectrometer, an Orbitrap, an ion mobility mass spectrometer, or any combination of these mass spectrometers.

17. A method, as claimed in claim 13, where said experimental tandem mass spectrum is that of a native N-glycan structure without any peptide attached, that of an N-glycan with a peptide attached, and that of a chemically derived N-glycan structure (such as a 2-aminobenzamide derived N-glycan or a permethylated N-glycan).

18. A method, as claimed in claim 2, where the monosaccharide sequences of unique outer branch structures of N-glycan structures are contained in said computer program.

19. A method, as claimed in claim 2, where the monosaccharide sequences of unique outer branch structures of N-glycan structures are entered by users of said computer program.

20. A method for representing asparagine linked glycan (N-glycan) structures and in silico generation of an N-glycan structure database, comprising
representing the core structure and the outer branch structures of each N-glycan structure separately;
representing the monosaccharide sequence of each unique outer branch structure of N-glycan structures using one string of characters from the Unicode character set;
representing each unique core structure using one string of characters from the Unicode character set;
generating a database of N-glycan structures;
the outer branch structures of each entry in said database being one of many unique combinations of said strings of characters representing the unique outer branch structures; and
the core structure of each entry being one of the strings of characters representing the core structures.


SEQUENCE LISTING (1 sequence)

SEQ ID NO: 1 - protein, 476 aa, Homo sapiens [sequence omitted]